(19) United States
(12) Patent Application Publication
(10) Pub. No.: US 2009/0273192 A1
(43) Pub. Date: Nov. 5, 2009

(54) Doubly fed axial flux induction generator

(76) Inventors: Mustafa K. Guven, Dunlap, IL (US); Shashank Krishnamurthy, Madison, WI (US)

Correspondence Address: CATERPILLAR/FINNEGAN, HENDERSON, L.L.P., 901 New York Avenue, NW, WASHINGTON, DC, 20001-4413, US

(21) Appl. No.: 12/149,345

(22) Filed: Apr. 30, 2008

(51) Int. Cl. H02P 9/04; F02D 29/06; F03D 9/00

(52) U.S. Cl. 290/40 C; 290/44; 290/40 R; 290/40 A; 322/29

(57) ABSTRACT

A doubly fed axial flux induction generator may include a prime mover configured to provide mechanical energy. The doubly fed axial flux induction generator may also include a rotor assembly coupled to the prime mover, wherein the prime mover is configured to rotate the rotor assembly. The doubly fed axial flux induction generator may further include a stator. The doubly fed axial flux induction generator may further include a power electronics module coupled to the rotor assembly and the stator, wherein the power electronics module is arranged in parallel with the prime mover, and is configured to assist with converting the mechanical energy into electrical energy, as well as with dispatching power between the prime mover and an energy storage device. The energy storage device may be coupled to the power electronics module, and may be configured to meet variations in power demand.

### TECHNICAL FIELD

The present disclosure relates generally to electric machines, and more particularly to a doubly fed axial flux induction generator.

### BACKGROUND

Many electric machines, such as electric motors and electric generators, include a stator and a rotor that rotates relative to the stator around a rotor rotation axis. The stator may include stator conductors and the rotor may include rotor conductors. As a prime mover rotates the rotor relative to the stator, the rotor conductors may be electrically excited to generate magnetic flux. The magnetic flux may flow from the rotor to the stator. Such electric machines may use the magnetic flux to transfer power between the stator and the rotor, producing voltage in the stator conductors. In the case of axial-flux electrical machines, the magnetic flux may flow across an axial gap between the rotor and the stator. The voltage in the stator conductors may be used to provide current for powering a customer load.

In some applications, the prime mover of an electrical machine may operate at variable speeds. For example, a customer load may be supplied with power from a wind machine, such as a wind turbine, whose speed may vary with changing wind conditions. Variations in the speed of the prime mover may cause fluctuations or changes in the output of the electrical machine. In some instances, it may be desirable to prevent the fluctuations or changes in output to prevent them from affecting the performance of electrically powered devices at the customer end.

At least one system has been developed for providing a generator that can be driven at a variable speed. U.S. Pat. No. 6,278,211 to Sweo (“Sweo”) discloses a brushless doubly-fed induction machine including dual cage rotors. The first and second cage rotors are mounted on a rotary shaft, with the first rotor disposed within a first annular stator. Conductors in the first and second cage rotors are connected to each other by a plurality of interconnection conductors disposed between the rotors, such that the conductors in the first cage rotor are connected to the conductors in the second cage rotor in a reverse phase sequence. The machine may be suitable for use in generator applications requiring a fixed frequency electrical output when driven at a variable speed or motor applications requiring limited variable speed operation when connected to an alternating current mains. Unfortunately, the size of the machine in Sweo may be unsuitable for certain applications. Also, the machine in Sweo may suffer from the same or similar inefficiencies inherent to radial flux electric machines.

The present disclosure is directed to overcoming one or more of the problems set forth above.

### SUMMARY

In one aspect, the presently disclosed embodiments may be directed to a doubly fed axial flux induction generator. The doubly fed axial flux induction generator may include a prime mover configured to provide mechanical energy. The doubly fed axial flux induction generator may also include a rotor assembly coupled to the prime mover, wherein the prime mover is configured to rotate the rotor assembly. The doubly fed axial flux induction generator may further include a stator. The doubly fed axial flux induction generator may further include a power electronics module coupled to the rotor assembly and the stator, wherein the power electronics module is arranged in parallel with the prime mover, and is configured to assist with converting the mechanical energy into electrical energy. The doubly fed axial flux induction generator may further include an energy storage device coupled to the power electronics module, configured to meet variations in power demand.

In another aspect, the presently disclosed embodiments may be directed to a method for generating electrical power for a customer load. The method may include determining a power requirement for the customer load. The method may also include determining an operating speed of a prime mover configured to rotate a rotor assembly relative to a stator. The method may further include calculating a level of excitation for the rotor assembly allowing the rotor assembly to emit a flow of axial flux that generates a voltage in the stator capable of meeting the power requirement. The method may further include producing the level of excitation in the rotor assembly by introducing current into the rotor assembly using a power electronics module arranged in parallel with the prime mover.

In another aspect, the presently disclosed embodiments may be directed to an electrical system. The electrical system may include a doubly fed axial flux induction generator configured to deliver electrical power to a customer load. The doubly fed axial flux induction generator may include a prime mover configured to provide mechanical energy. The doubly fed axial flux induction generator may also include a rotor assembly coupled to the prime mover, wherein the prime mover is configured to rotate the rotor assembly. The doubly fed axial flux induction generator may further include a stator. The doubly fed axial flux induction generator may further include a power electronics module coupled to the rotor assembly and the stator, wherein the power electronics module is arranged in parallel with the prime mover, and is configured to assist with converting the mechanical energy into electrical energy. The doubly fed axial flux induction generator may further include an energy storage device coupled to the power electronics module, configured to meet variations in power demand.

### BRIEF DESCRIPTION OF THE DRAWINGS

FIG. 1 is a schematic illustration of an electrical system, according to an exemplary embodiment of the present disclosure.

FIG. 2 is a flow diagram of a method for generating electrical power, according to an exemplary embodiment of the present disclosure.

### DETAILED DESCRIPTION

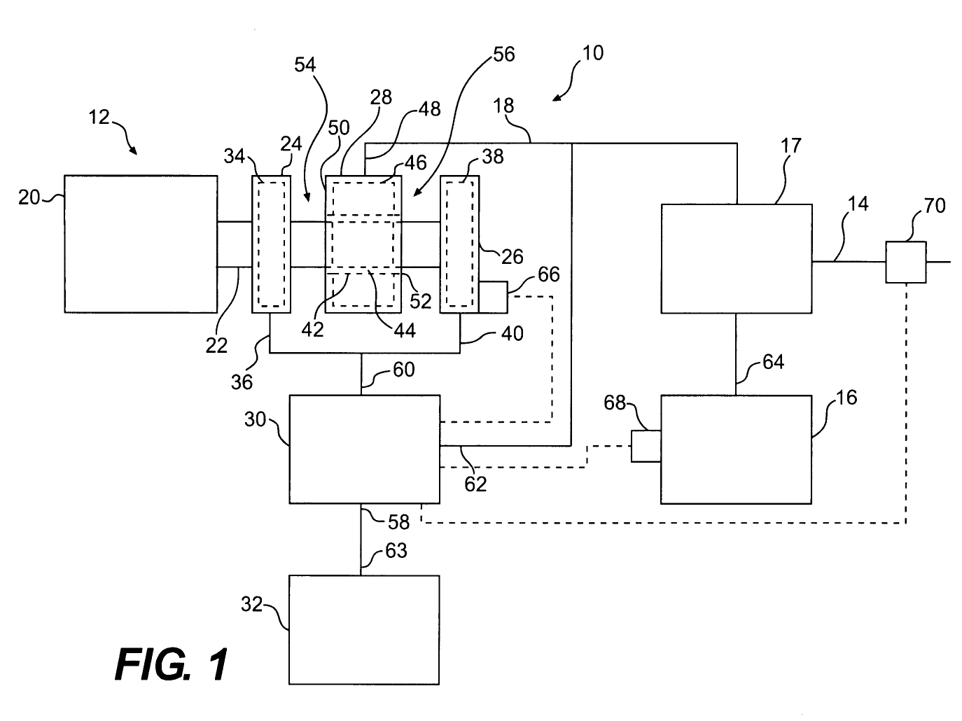

An exemplary electrical system 10 is shown in FIG. 1. Electrical system 10 may include a doubly fed axial flux induction generator 12, a utility line 14, a customer load 16, and a connection, such as, for example, a line interactive connection 17. One or more electrical conductors 18 may link doubly fed axial flux induction generator 12 to line interactive connection 17, and thus, customer load 16, with doubly fed axial flux induction generator 12 being configured to supply customer load 16 with electrical power. Doubly fed axial flux induction generator 12 may include a prime mover 20, a shaft 22, a rotor assembly including a proximal rotor 24 and a distal rotor 26, a stator 28, a power electronics module 30, and an energy storage device 32, with one or more electrical conductors 18 linking them together.

Prime mover 20 may include any suitable main power source configured to supply doubly fed axial flux induction generator 12 with mechanical energy. For example, prime mover 20 may include a wind turbine, internal combustion engine, or any other device capable of producing mechanical movement. The mechanical movement may include rotation of shaft 22, which may be rotatably coupled to prime mover 20.

Proximal rotor 24 may include a disk or plate coupled to a proximal portion of shaft 22. Due to the coupling, rotation of shaft 22 by prime mover 20 may cause rotation of proximal rotor 24. Proximal rotor 24 may also include a proximal rotor winding 34 and a proximal rotor terminal 36. Proximal rotor winding 34 may include one or more turns of an electrical conductor wound in the form of a coil. Proximal rotor 24 may include several such windings that may be spatially displaced from each other, and each of which may constitute an individual phase of a polyphase winding. Proximal rotor windings 34 may be composed of copper or any other suitable electrical conductor. Proximal rotor terminal 36 may be coupled to proximal rotor winding 34, and may include one or more points at which an electrical connection may be made.

Distal rotor 26 may include a disk or plate coupled to a distal portion of shaft 22. Due to the coupling, rotation of shaft 22 by prime mover 20 may also cause rotation of distal rotor 26. Distal rotor 26 may also include a distal rotor winding 38 and a distal rotor terminal 40. Distal rotor winding 38 may include one or more turns of an electrical conductor wound in the form of a coil. Distal rotor 26 may include several such windings that may be spatially displaced from each other, and each of which may constitute an individual phase of a polyphase winding. Distal rotor windings 38 may be composed of copper or any other suitable electrical conductor. Distal rotor terminal 40 may be coupled to distal rotor winding 38, and may include one or more points at which an electrical connection may be made.

Stator 28 may include a stationary disk or plate mounted in a housing (not shown) or any other suitable support. Proximal rotor 24 and distal rotor 26 may rotate relative to stator 28 whenever prime mover 20 rotates shaft 22. Stator 28 may include a central passage 42 through which shaft 22 may pass. It is contemplated that the surface defined by central passage 42 may be free from contact with shaft 22. It is also contemplated that a bearing assembly 44 may be inserted into central passage 42 to support shaft 22 while allowing shaft 22 to rotate relative to stator 28. Stator 28 may further include a stator winding 46 and a stator terminal 48. Stator windings 46 may include one or more turns of an electrical conductor wound in the form of a coil. Stator 28 may include several of such windings that may be spatially displaced from each other, and each of which may constitute an individual phase of a polyphase winding. Stator windings 46 may be composed of copper or any other suitable electrical conductor. Stator terminal 48 may be coupled to stator winding 46, and may include one or more points at which an electrical connection may be made.

Stator 28 may include a proximal surface 50 and a distal surface 52. Proximal surface 50 may face a distally facing surface of proximal rotor 24. Proximal surface 50 and the distally facing surface of proximal rotor 24 may be separated by a proximal air gap 54. Similarly, distal surface 52 may face a proximally facing surface of distal rotor 26. Distal surface 52 and the proximally facing surface of distal rotor 26 may be separated by a distal air gap 56.

Power electronics module 30 may include any suitable device capable of supplying and/or converting electric energy. For example, power electronics module 30 may include and/or use one or more semiconductors, magnetic components, capacitors, control electronics, and/or other supplementary components. Power electronics module 30 may be arranged in parallel with prime mover 20. Power electronics module 30 may include a power electronics module input terminal 58 for receiving electrical power from energy storage device 32, a power electronics module output terminal 60 for directing electrical power to proximal rotor 24 and distal rotor 26, and another power electronics output terminal 62 for directing electrical power to customer load 16. It is contemplated that energy storage device 32 may include a battery or any other suitable source of energy, and may include an energy storage device output terminal 63. Together, power electronics module 30 and energy storage device 32 may act as an uninterruptible power source. Additionally or alternatively, electrical power generated by doubly fed axial flux induction generator 12 and/or power electronics module 30 may replace or supplement electrical power from utility line 14.

Power electronics module 30 may also include a controller configured to control and adjust the electrical power supplied by power electronics module 30. The controller may include a single microprocessor or multiple microprocessors. Numerous commercially available microprocessors can be configured to perform the functions of the controller. It should be appreciated that the controller could readily embody a general power unit microprocessor capable of controlling numerous power related functions. Various other known circuits may be associated with the controller, including power supply circuitry, signal-conditioning circuitry, solenoid driver circuitry, communication circuitry, and other appropriate circuitry.

Customer load 16 may include one or more devices connected to and drawing current from doubly fed axial flux induction generator 12 and/or utility line 14. Customer load 16 may include a customer load input terminal 64 through which electrical power may be received. One or more electrical conductors 18 may connect customer load 16 to doubly fed axial flux induction generator 12 by linking customer load input terminal 64 with stator terminal 48. One or more electrical conductors 18 may also connect proximal rotor terminal 36 with distal rotor terminal 40, power electronics module 30 with proximal rotor terminal 36 and distal rotor terminal 40, power electronics module 30 with stator terminal 48 and customer load input terminal 64, and power electronics module 30 with energy storage device 32. It is contemplated that one or more electrical conductors 18 may include one or more electrical lines for three phase electrical power transmission, which may be the type of electrical power used and/or produced by doubly fed axial flux induction generator 12, supplied by utility line 14, and consumed by customer load 16.

Power electronics module 30 may be coupled to a prime mover speed sensor 66. Prime mover speed sensor 66 may be configured to sense prime mover speed, which may be expressed in revolutions per minute of shaft 22, proximal rotor 24, or distal rotor 26. Prime mover speed sensor 66 may be mounted on or near prime mover 20, shaft 22, proximal rotor 24, or distal rotor 26.

Power electronics module 30 may communicate with one or more current or voltage sensors. A customer load sensor 68 may sense the amount of current, voltage, or power consumed by customer load 16. It is also contemplated that customer load sensor 68 may be used to monitor electrical power received at and/or required by customer load 16. Customer load sensor 68 may be coupled to customer load input terminal 64. A utility line sensor 70 may be coupled to utility line 14 and may be configured to detect current or voltage in utility line 14. Additionally or alternatively, utility line sensor 70 may also be coupled to line interactive connection 17. Power electronics module 30 may use the information it receives from prime mover speed sensor 66, customer load sensor 68, and/or utility line sensor 70 to control doubly fed axial flux induction generator 12. Sensors may also be available for energy storage device 32 to detect its voltage, temperatures, and/or state of charge, for example, in the case of batteries.

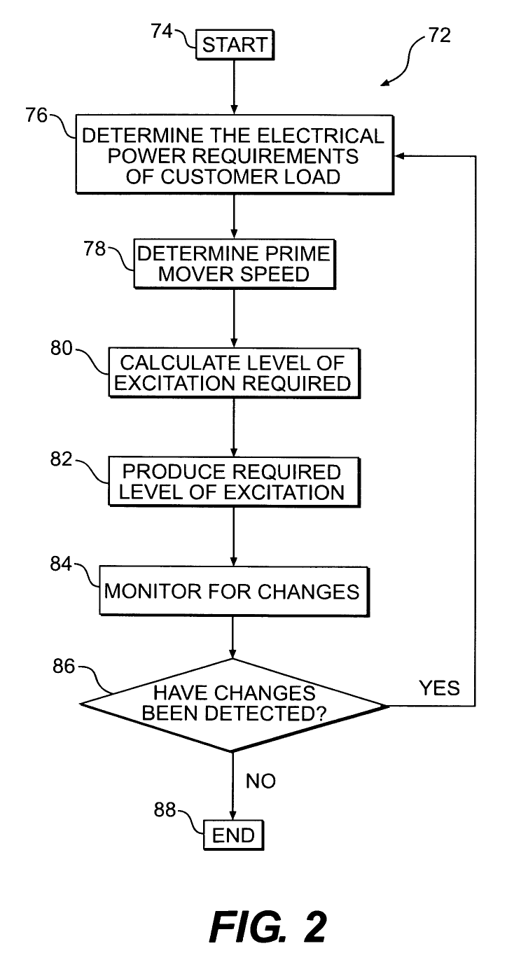

A method 72 for controlling the operation of doubly fed axial flux induction generator 12 is shown in FIG. 2. Method 72 may start with prime mover 20 rotating shaft 22 (step 74). Power electronics module 30, using customer load sensor 68 and/or utility line sensor 70, may determine the type and/or quantity of electrical power that doubly fed axial flux induction generator 12 should supply to customer load 16 (step 76). To accomplish this, power electronics module 30 may compare the power requirements of customer load 16 with the electrical power being delivered to customer load 16 by utility line 14, as indicated by utility line sensor 70. If the electrical power required by customer load 16 exceeds the electrical power being delivered by utility line 14, power electronics module 30 may recognize the difference as being indicative of the type and/or quantity of electrical power that doubly fed axial flux induction generator 12 should generate for customer load 16.

In order to generate the desired amount of electrical power, power electronics module 30 may consider at least two factors. One factor may be the prime mover speed. Another factor may be the level (magnitude and/or frequency) of excitation of proximal rotor winding 34 and/or distal rotor winding 38. The prime mover speed, and the level of excitation of proximal rotor winding 34 and distal rotor winding 38, may affect the rate of flow of magnetic flux from proximal rotor 24 to stator 28, and/or from distal rotor 26 to stator 28. The magnetic flux may produce voltage in stator winding 46, and hence, the type and/or quantity of electrical power delivered to customer load 16 by doubly fed axial flux induction generator 12 may depend on the rate of flow of the magnetic flux. Essentially, by exciting proximal rotor winding 34 and distal rotor winding 38 during rotation of proximal rotor 24 and distal rotor 26, mechanical energy from prime mover 20 may be converted into electrical energy in stator 28. Thus, prime mover 20, proximal rotor 24, distal rotor 26, stator 28, power electronics module 30, and energy storage device 32, may operate as a mechanical to electrical energy converter.

If the prime mover speed increases while the level of excitation remains the same, the rate of flow of magnetic flux will increase as a result, as will the voltage and/or frequency in stator winding 46 and the electrical output delivered to customer load 16. A decrease in the prime mover speed under the same conditions will have the opposite effect, that is, less voltage and/or frequency will be produced in stator winding 46, and less electrical power will be delivered to customer load 16. Similarly, if the level of excitation of proximal rotor winding 34 and/or distal rotor winding 38 increases while the prime mover speed remains the same, the rate of flow of magnetic flux will increase as a result, as will the voltage in stator winding 46 and the electrical output delivered to customer load 16. A decrease in the level of excitation under the same conditions may have the opposite effect, that is, less voltage will be produced in stator winding 46, and less electrical power may be supplied to customer load 16. An increase in both the prime mover speed and the level of excitation may increase the amount of electrical power delivered, while a decrease in both may have the opposite effect.

Power electronics module 30 may determine the prime mover speed using prime mover speed sensor 66 (step 78). Based on the determined prime mover speed, power electronics module 30 may calculate the level of excitation required to produce the electrical power determined in step 76 (step 80). Power electronics module 30 may then direct a current into proximal rotor winding 34 and/or distal rotor winding 38 designed to produce the level of excitation calculated in step 80 (step 82). Accordingly, customer load 16 may receive the electrical power it requires.

Power electronics module 30 may monitor for changes, such as, for example, changes in the prime mover speed and/or changes in the customer load power requirements (step 84). In order to detect changes in the prime mover speed, power electronics module 30 may continue to monitor prime mover 20 using prime mover speed sensor 66. Additionally or alternatively, power electronics module 30 may continue to monitor customer load 16 using customer load sensor 68 to detect changes in the electrical power requirements of customer load 16. Additionally or alternatively, power electronics module 30 may monitor utility line 14 using utility line sensor 70 to detect changes in the electrical power delivered by utility line 14. As long as no changes are detected (step 86, NO), power electronics module 30 may maintain doubly fed axial flux induction generator 12 in its current state of operation, and method 72 may end (step 88). If a change is detected (step 88, YES), power electronics module 30 may return to step 76. It is also contemplated that even if changes are not detected, power electronics module 30 may return to step 76, allowing power electronics module 30 to continually monitor for changes and make adjustments if desired.

While a variation in the prime mover speed can change the type and/or quantity of electrical power produced by doubly fed axial flux induction generator 12, power electronics module 30 may act to reduce or eliminate the effects of the change if they are undesirable. The effects of the change may be undesirable if, for instance, customer load 16 requires a consistent type and/or quantity of electrical power. In such cases, if power electronics module 30 detects a change in prime mover speed at step 84, power electronics module 30 may return to step 76 of method 72. In performing step 76, power electronics module 30 may determine that the electrical power requirements for customer load 16 have not changed. Power electronics module 30, upon determining the prime mover speed at step 78, may calculate the level of excitation required to produce the required electrical power at the determined prime mover speed (step 80). Since the prime mover speed has changed while the electrical power requirements for customer load 16 have not, power electronics module 30 may adjust the level of excitation to compensate for the change in the prime mover speed, thus keeping the electrical power produced by doubly fed axial flux induction generator 12 substantially constant.

In other instances, the electrical power requirements of customer load 16 may change, and in order to continue to meet the electrical power requirements, power electronics module 30 may adjust the level of excitation to prevent customers from receiving too much or too little electrical power, depending on whether the electrical power requirements go up or down. For example, if the electrical power coming through utility line 14 decreases, customer load 16 may require extra electrical power from doubly fed axial flux induction generator 12 to make up for the loss in electrical power coming from utility line 14. Power electronics module 30 may sense the decrease in electrical power from utility line 14 using utility line sensor 70. Accordingly, power electronics module 30 may return to step 76. Upon comparing the decreased electrical power from utility line 14 to the power requirements of customer load 16, power electronics module 30 may determine that the electrical power that customer load 16 requires from doubly fed axial flux induction generator 12 has increased. After determining the prime mover speed at step 78, power electronics module 30 may calculate the level of excitation required (step 80). In response to the decrease in the electrical power delivered by utility line 14, the level of excitation required may be increased to compensate. Thus, power electronics module 30 may inject more current into proximal rotor winding 34 and/or distal rotor winding 38 to increase the voltage produced in stator winding 46, and increase the current supplied to customer load 16. Power electronics module 30 may perform similar steps in response to increased power consumption at customer load 16.

If the electrical power coming through utility line 14 increases, customer load 16 may require less electrical power from doubly fed axial flux induction generator 12 to meet its requirements. Power electronics module 30 may sense the increase in electrical power from utility line 14 using utility line sensor 70. Accordingly, power electronics module 30 may return to step 76. Upon comparing the increased electrical power from utility line 14 to the power requirements of customer load 16, power electronics module 30 may determine that the electrical power that customer load 16 requires from doubly fed axial flux induction generator 12 has decreased. After determining the prime mover speed at step 78, power electronics module 30 may calculate the level of excitation required (step 80). In response to the increase in electrical power from utility line 14, the level of excitation required may be decreased to compensate. Power electronics module 30 may perform similar steps in response decreased power consumption at customer load 16.

Although the previous examples describe isolated changes in electrical system 10, it should be understood that the prime mover speed, the electrical power supply from utility line 14, and/or the power requirements of customer load 16, may change simultaneously in some instances, and may change in different directions (i.e., increase or decrease), and in varying magnitudes. In any case, power electronics module 30 may sense the changes, and by performing method 72, may adjust the level (of magnitude and/or frequency) of excitation of proximal rotor winding 34 and distal rotor winding 38 to adjust the flow of electrical power delivered by doubly fed axial flux induction generator 12 in response to the changes. Additionally or alternatively, power electronics module 30 may deliver either more or less electrical power to customer load 16 via power electronics module output terminal 62 in response to the changes. Further, power electronics module 30 may assist in dispatching power from prime mover 20 and from/to energy storage device 32, according to the demand of customer load 16 and/or utility 14. Thus, power electronics module may help to ensure that the power requirements of customer load 16 are met even under variable or transient operating conditions.

### INDUSTRIAL APPLICABILITY

A doubly fed axial flux induction generator 12 and method 72 for generating electrical power may be useful in almost any type of electrical system 10. For example, doubly fed axial flux induction generator 12 and method 72 may be suitable for supplying electrical power for use in a power grid, a facility, and/or a machine. Processes and methods consistent with the disclosed embodiments may provide an efficient way to supplement or replace electrical power normally received from a utility line 14 to help ensure that a customer load 16 receives the electrical power it requires.

Electrical system 10 may experience variations during operation. Such variations may occur as a result of changes in the operating speed of a prime mover 20 of doubly fed axial flux induction generator 12, changes in the electrical power requirements of customer load 16, and/or changes in the electrical power supplied by utility line 14. Such variations can cause undesirable fluctuations in the electrical power delivered to customer load 16. Doubly fed axial flux induction generator 12 may compensate for the variations by monitoring itself and electrical system 10 using one or more sensors 66, 68, and 70, and adjusting its operation to reduce or eliminate the undesirable fluctuations. As such, doubly fed axial flux induction generator may improve the overall quality of the electrical power delivered to customer load 16, even under transient operating conditions.

Improving operation under transient conditions may be of particular importance in the field of wind energy. Wind turbines may be used as prime movers to provide mechanical energy, and that mechanical energy may be transformed into electrical power. However, wind turbines may operate at variable speeds, where the speed may be dependent on wind conditions. Since doubly fed axial flux induction generator 12 can detect and compensate for changes in prime mover speed, doubly fed axial flux induction generator 12 may help to ensure that power quality can be maintained at customer load 16 in spite of changing wind conditions. Accordingly, doubly fed axial flux induction generator 12 may be well suited for wind energy applications.

Furthermore, the arrangement of a power electronics module 30 of doubly fed axial flux induction generator 12 may allow power electronics module 30 to not only regulate the electrical power produced by doubly fed axial flux induction generator 12, but also deliver additional electrical power to customer load 16. Power electronics module 30 may deliver additional electrical power to customer load 16 as a result of its parallel arrangement with respect to prime mover 20. Essentially, since power electronics module 30 may be operatively coupled to a proximal rotor 24, a distal rotor 26, and customer load 16, power electronics module 30 may be capable of not only exciting proximal rotor 24 and distal rotor 26, but also delivering electrical power in a more direct way to customer load 16, thus eliminating the need for multiple power electronics modules. This may reduce the footprint of doubly fed axial flux induction generator, while also reducing cost by eliminating extraneous components.

It will be apparent to those skilled in the art that various modifications and variations can be made in the disclosed system and method without departing from the scope of the disclosure. Additionally, other embodiments of the disclosed system and method will be apparent to those skilled in the art from consideration of the specification. It is intended that the specification and examples be considered as exemplary only, with a true scope of the disclosure being indicated by the following claims and their equivalents.

What is claimed is:

1. A doubly fed axial flux induction generator, comprising:
a prime mover configured to provide mechanical energy;
a rotor assembly coupled to the prime mover, wherein the prime mover is configured to rotate the rotor assembly;
a stator;
a power electronics module coupled to the rotor assembly and the stator, wherein the power electronics module is arranged in parallel with the prime mover, and is configured to assist with converting the mechanical energy into electrical energy; and
an energy storage device coupled to the power electronics module, configured to meet variations in power demand.

2. The doubly fed axial flux induction generator of claim 1, wherein the prime mover is one of a wind turbine and an internal combustion engine.

3. The doubly fed axial flux induction generator of claim 1, wherein the rotor assembly includes a proximal rotor and a distal rotor.

4. The doubly fed axial flux induction generator of claim 3, wherein the prime mover is configured to provide mechanical energy by rotating a shaft.

5. The doubly fed axial flux induction generator of claim 4, wherein the proximal rotor and the distal rotor are coupled to the shaft, and rotate with the shaft about a rotational axis extending through the shaft.

6. The doubly fed axial flux induction generator of claim 3, wherein the stator is separated from the proximal rotor by a proximal air gap, and the stator is separated from the distal rotor by a distal air gap.

7. The doubly fed axial flux induction generator of claim 3, wherein the proximal rotor includes a proximal rotor winding, the distal rotor includes a distal rotor winding, and the stator includes a stator winding.

8. The doubly fed axial flux induction generator of claim 7, wherein the power electronics module is coupled to the proximal rotor winding, the distal rotor winding, and the stator winding.

9. The doubly fed axial flux induction generator of claim 7, wherein the power electronics module is configured to excite the proximal rotor winding and the distal rotor winding during rotation of the proximal rotor and the distal rotor to generate a voltage in the stator winding.

10. A method for generating electrical power for a customer load, comprising:
determining a power requirement for the customer load;
determining an operating speed of a prime mover configured to rotate a rotor assembly relative to a stator;
calculating a level of excitation for the rotor assembly allowing the rotor assembly to emit a flow of axial flux that generates a voltage in the stator capable of meeting the power requirement; and
producing the level of excitation in the rotor assembly by introducing current into the rotor assembly using a power electronics module arranged in parallel with the prime mover.

11. The method of claim 10, wherein determining the power requirement includes calculating the difference between electrical power required by the customer load and electrical power delivered to the customer load by a utility line.

12. The method of claim 10, wherein calculating the level of excitation for the rotor assembly includes calculating the level of excitation for the rotor assembly based on the power requirement and the operating speed.

13. The method of claim 10, wherein generating the voltage in the stator includes generating the voltage in a stator winding coupled to the customer load and the power electronics module.

14. The method of claim 10, wherein introducing current into the rotor assembly includes introducing current into rotor windings coupled to the power electronics module.

15. The method of claim 10, further including monitoring at least one of the operating speed and the power requirement to detect a change in at least one of the operating speed and the power requirement.

16. The method of claim 15, further including compensating for the change in the operating speed by adjusting the level of excitation.

17. The method of claim 16, wherein compensating for the change in the operating speed includes one of increasing the level of excitation upon detecting a decrease in the operating speed, and decreasing the level of excitation upon detecting an increase in the operating speed.

18. The method of claim 15, further including compensating for the change in the power requirement by adjusting the level of excitation.

19. The method of claim 18, wherein compensating for the change in the power requirement includes one of increasing the level of excitation upon detecting an increase in the power requirement, and decreasing the level of excitation upon detecting a decrease in the power requirement.

20. An electrical system, comprising:
a doubly fed axial flux induction generator configured to deliver electrical power to a customer load, wherein the doubly fed axial flux induction generator includes:
a prime mover configured to provide mechanical energy;
a rotor assembly coupled to the prime mover, wherein the prime mover is configured to rotate the rotor assembly;
a stator;
a power electronics module coupled to the rotor assembly and the stator, wherein the power electronics module is arranged in parallel with the prime mover, and is configured to assist with converting the mechanical energy into electrical energy; and
an energy storage device coupled to the power electronics module, configured to meet variations in power demand.
